(19) United States
(12) Patent Application Publication
(10) Pub. No.: US 2013/0140218 A1
(43) Pub. Date: Jun. 6, 2013

(54) FROTH FLOTATION AND APPARATUS FOR SAME

(71) Applicants: Glenn S. Dobby, Toronto (CA); Glenn A. Kosick, Toronto (CA)

(72) Inventors: Glenn S. Dobby, Toronto (CA); Glenn A. Kosick, Toronto (CA)

(21) Appl. No.: 13/577,279

(22) PCT Filed: Feb. 1, 2011
(86) PCT No.: PCT/CA11/00113

§ 371 Date: Oct. 19, 2012

Related U.S. Application Data
(60) Provisional application No. 61/301,679, filed on Feb. 5, 2010.

(51) Int. Cl. B03D 1/02; B03D 1/14

(52) U.S. Cl. CPC B03D 1/02; B03D 1/14
USPC 209/164; 209/169

(57) ABSTRACT

A flotation cell and a method of froth flotation. The flotation cell comprises a first vessel portion and a second vessel portion. The first vessel portion has a feed slurry input, an agitator and a gas input located in or operatively connected thereto. The first vessel portion is a mechanically agitated pressure vessel and acts as a particle collection unit. The second vessel portion has a tailings output and a froth discharge operatively connected thereto. The second vessel portion is hydraulically connected to the first vessel portion and receives agitated slurry and gas from the first vessel portion. The second vessel portion acts as a bubble disengagement unit.

### FIELD OF THE INVENTION

This invention relates to the field of froth flotation and to an apparatus and method for accomplishing froth flotation.

### BACKGROUND OF THE INVENTION

Froth flotation has been used for more than a century in the mining industry to separate mineral particles from waste particles in slurries. Other resource industries also use froth flotation to separate such things as oil from sand or waste, ink from a pulp and waste from pulp in the pulp and paper industry.

Using the mining industry as an example, after rock is mined in many instances it is crushed and then ground down to the consistency of mud and diluted with water to form a slurry (often having in the general range of approximately 30% solids by weight). In the oil sands industry the grinding step may not be required and the sand laden oil may be mixed directly with water to form a slurry. Once the ore is in slurry form, subsequent steps are required to then separate the desired mineral or oil from the waste or sand particles. The most common next unit of operation used to achieve such separation is called froth flotation.

The process of froth flotation involves several steps. First, chemicals called surfactants are typically added to the slurry to reduce surface tension of the water and, in the case of minerals, to coat the mineral surface with a molecular layer of surfactant causing the mineral to become hydrophobic. In the oil sands industry oil is already naturally hydrophobic and a surfactant may not be necessary, or not necessary to the same degree. The second step of the process typically involves injecting gas bubbles (commonly air) into the slurry, which is contained within a vessel. Next, energy is applied to the slurry to force the mineral or oil particles onto the gas bubbles causing the bubbles to lift or raise the mineral or oil particles to the top of the vessel. At that point the mineral or oil laden gas bubbles (froth) can be removed from the surface of the vessel for subsequent processing by more flotation units or by other process operations.

There are typically a number of different methods of applying energy to the process to force the mineral or oil particles onto the gas bubbles. One recognized method is through the utilization of a tall vessel (often 10-15 meters in height) where the slurry is introduced nearer the top of the vessel and air is introduced toward the bottom. The air is typically introduced using sparging techniques or through pumping tailings from the bottom of the cell, and then back into the bottom of the cell through a restriction in the line such as a fixed spiral or orifice to which air is added. The falling particles in the slurry tend to collide with rising bubbles and make contact. The bubbles then form a froth at the top of the vessel and overflow into a launder for collection. This particular form of froth flotation is often referred to as column flotation and the vessel in use is typically referred to as a column flotation cell.

The second common method of applying the energy to the flotation process is through contacting feed slurry (as opposed to tailing slurry discussed above) and air through a pressure drop in a pipe, and then discharging the slurry into a vessel for gas/slurry disengagement. The resulting froth is then removed from the top of the vessel, similar to the situation in column flotation. An example of this type of flotation cell is the contact cell and the Jameson cell and the pneumatic cell.

A third common method utilized to apply energy to the flotation process involves using an agitator in an open top vessel to stir the slurry vigorously, while simultaneously injecting or aspirating gas down the shaft of the agitator such that the slurry particles are forced into contact with the gas bubbles that are generated at the impeller tip. The bubbles attached to the particles then float to the top of the vessel and are removed in a similar fashion to that of column flotation. Such mechanically agitated flotation cells are referred to in the industry as mechanical cells or conventional cells. Those cells can be rectangular or circular in shape and often tend to be considerable in size. The circular mechanical cells (or tanks) are typically referred to as tank cells. The tank cell concept is approximately 20 years old, while rectangular mechanical flotation cells have been in use for closer to 100 years.

Mechanical flotation cells are one of the most commonly used flotation cells in the mining and oil sands industry. It is estimated that they comprise over 90% of the flotation capacity in use today. These cells or vessels typically have an impeller that sits within a nest of baffles referred to as a stator. The impeller agitates the slurry to keep the slurry in suspension, to generate gas bubbles and to force particles onto the gas bubbles. As mentioned, the mineral or oil laden bubbles then float to the top of the vessel where they form a froth that is subsequently removed to report to another stage of flotation or another processing operation. In current mechanically agitated flotation cells, the mechanical agitation and the separation of the gas from the slurry takes place in the same vessel. The vessels are usually combined in series to form what is referred to in the industry as a bank of flotation cells. Many times multiple banks of flotation cells are used in parallel, depending on the size of the mining operation. Such mechanically agitated flotation cells are one of the most widely used cells (particularly in primary or rougher flotation circuits) because of their ability to create generally higher bubble shear than other types of flotation machines.

In all three of the types of the froth flotation cells described above, there is a froth-slurry interface at the top of the cells. When the rising mineral laden bubble reaches the interface its velocity slows dramatically, resulting in a shock that in some cases can dislodge mineral particles from the bubble. In the case of flotation cells that are in use today, the particles that are dislodged from bubbles (either at the froth-slurry interface, or within the body of the froth) fall or drop back into the slurry and must be reattached to a bubble within that vessel or, alternatively, have to report to a subsequent collection or processing stage. In large flotation cells with a low mass flux of minerals to the froth, the amount of minerals dropping back into the froth can be as high as 80 to 90%. Mathematical modelling of froth flotation processes commonly will apply a froth recovery factor to account for the drop back effect.

Over the years there has been a tendency to increase the size of flotation cells in order to obtain desired residence times, however, an undesirable side effect has been that with an increase in vessel surface area there tends to be an increase in particle drop back. With an increase in the size of the flotation machine there is usually also an increase in its energy requirement. Conventional mechanically agitated flotation machines use a significant amount of energy and flotation cell volume in order to keep the slurry in suspension. Increased amounts of energy and flotation cell volume are also typically necessary to recollect mineral particles that drop back from the froth/slurry interface. In addition, since there are often a number of flotation cells working together as the flotation circuit, particles that are rejected from the slurry in latter vessels in the series do not have the full residence time of the complete series for recollection. As a result, it is generally accepted in the industry that particle drop back in latter vessels in a series of flotation cells is usually higher than in earlier vessels because there is less hydrophobic solids being recovered, with a consequent low froth stability.

There is therefore a need for a more efficient method of froth flotation and a more efficient apparatus for use in a froth flotation system that addresses the issues of particle drop back and energy consumption. Historically, in order to ensure adequate through-put in a flotation system, equipment manufacturers have tended to make vessels larger and larger so that they maintain an adequate through-put while still being able to account for a particle drop-back. Unfortunately, as a general rule of thumb the larger the vessel the more inefficient it becomes from an energy consumption standpoint.

### SUMMARY OF THE INVENTION

The invention therefore provides a new and useful flotation cell for froth flotation that address a number of the deficiencies in the prior art. The invention also provides a new useful method of froth flotation.

Accordingly, in one of its aspects the invention provides a flotation cell for froth flotation, the flotation cell comprising one or more flotation vessels; a feed slurry input; a tailings output; a froth output; a gas input; a flow restrictor positioned in one of said one or more flotation vessels; and, a particle drop back output associated with said flow restrictor, when said flotation cell undergoing froth flotation said flow restrictor limiting the drop back of floated particles into the slurry and directing drop back particles to said particle drop back output.

In a further aspect the invention provides a flotation cell comprising a first vessel portion, said first vessel portion having a feed slurry input, an agitator and a gas input located in or operatively connected thereto, said first vessel portion comprising a mechanically agitated pressure vessel and acting as a particle collection unit; and, a second vessel portion having a tailings output and a froth discharge operatively connected thereto, said second vessel portion hydraulically connected to said first vessel portion and receiving agitated slurry and gas from said first vessel portion, said second vessel portion acting as a bubble disengagement unit.

The invention also concerns a method of froth flotation, the method comprising directing a feed slurry into a flotation vessel; injecting gas into the feed slurry either prior to or after the slurry enters the flotation vessel; agitating the slurry to cause gas bubbles to attach to hydrophobic particles in the slurry such that the bubbles and the attached hydrophobic particles rise within the vessel and form a froth; with a flow restrictor, positioned higher in the vessel than the point of entry of the feed slurry, diverting drop back particles from the froth to a particle drop back output, thereby limiting the intermixing of the drop back particles with the slurry and limiting the diversion of the drop back particles to tailings.

In still a further aspect the invention provides a method of froth flotation comprising delivering a slurry containing hydrophobic particles to a first vessel portion of a flotation cell, the first vessel portion comprising a pressure vessel; injecting gas into the slurry either prior to or after the slurry enters the first vessel portion; agitating the slurry to cause the adherence of gas bubbles to the hydrophobic particles, the first vessel portion acting as a particle collection unit; and, transporting the agitated slurry and gas into a second vessel portion to permit bubble disengagement from the slurry and particle separation in a vessel distinct from the particle collection unit.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention which:

FIG. 1 is a schematic illustration of a flotation cell constructed in accordance with one of the preferred embodiments of the present invention;

FIG. 2 is a schematic illustration of an alternate embodiment of the flotation cell shown in FIG. 1;

FIG. 3 is a schematic illustration of three of the flotation cells of FIG. 1 shown as they may be connected in series in a flotation operation;

FIG. 4 is a schematic illustration of a further alternate embodiment of the flotation cell shown in FIG. 1;

FIG. 5 is a schematic illustration of a flotation cell constructed in accordance with a further embodiment of the present invention;

FIG. 6 is a schematic illustration of an alternate embodiment of the flotation cell shown in FIG. 5;

FIG. 7 is an upper plan view of the flow restrictor shown in FIG. 6;

FIG. 8 is a schematic illustration of a contact flotation cell constructed in accordance with one of the preferred embodiments of the present invention; and,

FIG. 9 is a schematic illustration of an alternate embodiment of the contact flotation cell shown in FIG. 8.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

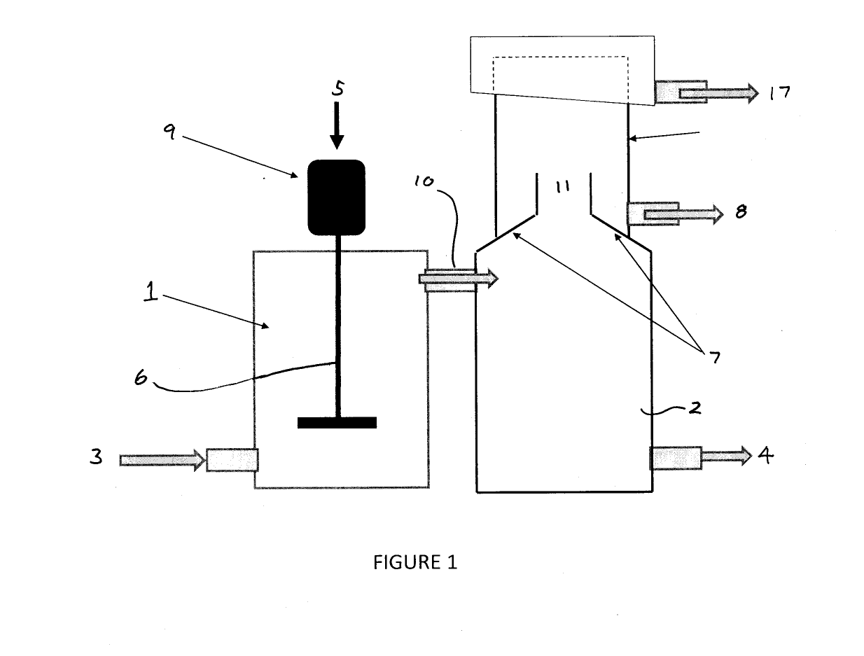

With reference to FIG. 1, there is shown in schematic illustration an overall flotation cell (including many of its significant components), for use in froth flotation, constructed in accordance with one of the preferred embodiments of the present invention. In the embodiment of the invention shown, the flotation cell is comprised of a first vessel portion 1 and a second vessel portion 2. However, as discussed below, there exists a number of alternate embodiments that fall within the broad concept of the invention.

With reference to FIG. 1, the flotation cell shown further includes a feed slurry input 3, a tailings output 4, a gas input 5, an agitator 6, a flow restrictor 7, a froth discharge or output 17 and a particle drop back output 8 that, as is discussed below, is associated with flow restrictor 7. It will be appreciated by those skilled in the art having a thorough understanding of the invention that the precise nature, configuration and location of each of the feed slurry input, tailings output, gas input, agitator, flow restrictor and particle drop back output may vary widely while remaining within the broad scope of the invention. Some of those variations are shown in the attached drawings and described herein, while others will be readily apparent to those skilled in the art. It will also be appreciated that depending upon the particular type of flotation cell utilized agitator 6 may or may not be required. In the case of invention where the flotation cell includes first and second vessel portions 1 and 2 (as shown in FIG. 1) the first vessel portion will be mechanically agitated, have an enclosed upper surface or top and comprises a pressure vessel. From a thorough understanding of the invention it will be understood that with first vessel portion 1 in the form of a pressure vessel the gas and slurry will not tend to separate into distinct phases in the first vessel portion.

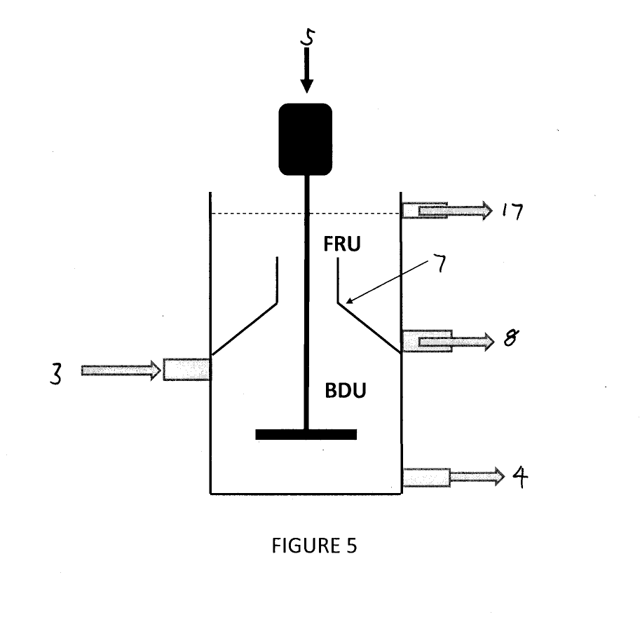

In the embodiment of the invention shown in FIG. 1 the flotation cell consists generally of three distinct compartments (however, as will be discussed later in alternate embodiments there may instead by 2 compartments - see FIG. 5, for example). The three compartments allow for the decoupling or separation of three separate stages of the froth flotation process. The first stage is referred to as a particle collection stage where hydrophobic particles are brought into contact with gas bubbles. The second stage is referred to as a bubble disengagement stage where gas bubbles rise upwardly in order to generally separate the hydrophobic particles of the slurry from the tailings, which typically exit the bottom of the vessel in question without carrying any significant degree of gas bubbles. The gas bubbles that rise upwardly in the second stage and into the third stage are carried by enough slurry to prevent bubble coalescence. The third stage is referred to as froth recovery. These three stages of the flotation process are carried out in compartments referred to generally as the particle collection unit (PCU), the bubble disengagement unit (BDU) and the froth recovery unit (FRU). In one embodiment the interface between the bubble disengagement unit and the froth recovery unit is defined by a flow restrictor (or throttling plates) which is described in more detail below. In other embodiments of the invention a flow restrictor may not be utilized (for example, where froth drop back is very low). Where a flow restrictor is present, there will be two product streams created in the froth recovery unit; namely, the froth product that overflows the top of the vessel, and that is directed through froth discharge 17, and an underflow stream which carries slurry that entered the froth recovery stage, as well as drop back hydrophobic particles that have been rejected from the froth. In this instance the three units essentially operate as a single flotation unit or cell that, unlike traditional flotation cells, produces a third product stream which has been referred to as the froth underflow or particle drop back stream.

With reference again to the embodiment of the invention shown in FIG. 1, in this embodiment the first vessel portion 1 comprises a particle collection unit that is in the form of a mechanically agitated pressure vessel. The reagentized slurry, having hydrophobic particles therein, is either gravity fed or pumped into first vessel portion 1. Air or gas will then be commonly introduced into first vessel portion 1 through (a) the use of either a pipe or sparging device (positioned through the vessel wall and preferably below the agitator impeller), and/or (b) through injecting into the feed stream and/or (c) through injecting through the center of a hollow agitator shaft. Regardless, the highly agitated slurry in the presence of gas, together with the introduction of appropriate chemicals common for froth flotation, causes the desired particles in the slurry to attach to gas bubbles, a process referred to as bubble/particle collection. Since first vessel portion 1 is a sealed unit under low pressure, the slurry and gas bubbles are caused to exit the vessel together (with little or no bubble disengagement or separation of the gas and slurry phases) and are transported through a conduit or nozzle 10 which hydraulically connects the first and second vessel portions. While the operating parameters of the flotation cell will vary depending upon the particular application at hand, it is expected that in many instances the total pressure required in the feed end of the system will be from approximately 5 to approximately 10 psi gauge.

The second vessel portion, the lower portion of which in this instance operates as the bubble disengagement unit, is preferably sized to allow enough time for disengagement of the gas from the slurry. In this context, disengagement means that gas bubbles are allowed to flow upwardly carrying with them a smaller amount of the slurry, while the bulk of the slurry flows downwardly within the vessel and eventually out the tailings output 4. This result may be achieved in generally one of two different ways. First, the size of second vessel portion 2 can be such that there is sufficient surface area so that the downward velocity of the slurry is low enough to prevent gas bubbles from being drawn downwards and out the bottom of the vessel with the slurry stream. The second approach to achieve bubble-slurry disengagement is to feed the slurry into second vessel portion tangentially, with sufficient velocity to establish a tangential flow of slurry within the vessel. This flow will tend to preferentially concentrate particles on the outside of the vessel and gas bubbles on the inside, which will thereby assist in their disengagement and upward movement. A combination of the two approaches could also be used.

It will be understood that without additional structure within the bubble disengagement unit particle drop back may occur with desired particles or minerals tending to exit the under flow discharge of second vessel portion 2 and be either lost to tailings or directed to a subsequent flotation stage. For that reason, flow restrictor 7 may be positioned (in this embodiment of the invention) in second vessel portion 2 at a location that is vertically higher in the vessel than the feed input slurry (in this case vertically higher than hydraulic conduit or nozzle 10). This positioning of the flow restrictor within second vessel portion 2 generally has the effect of causing an increase in the flow rate of froth/slurry mixture through a defined section of the flotation cell, and in particular the immediate vicinity of the flow restrictor. The portion of second vessel 2 situated immediately above the flow restrictor operates as the froth recovery unit, into which bubbles flowing upwardly through the second vessel portion are directed until such time as they become froth that overflows the top of the vessel to form the froth product that is extracted through froth discharge 17. As its name suggests, the flow restrictor acts as a restriction in the flow that allows the bubbles to proceed into the upper portion of second vessel 2 at a high gas holdup, while remaining in a relatively bubbly flow regime but not specifically a froth. It is important to note that the increased velocity of the gas (and any entrained slurry) through the flow restrictor helps to minimize the return flow of slurry and any drop back particles from the froth recovery stage downwardly into the bubble disengagement unit beneath the flow restrictor. It is also important to note that the flow restrictor is positioned completely within the slurry phase and does not extend up into the froth. For that reason the flow restrictor does not act as a froth collector, crowder or launder.

Flow restrictor 7 may be configured in a variety of different forms while remaining within the broad scope of the invention. Some of those forms are discussed below and shown in the attached drawings while others will be readily apparent to those skilled in the art. With reference to FIG. 1, flow restrictor 7 is in the form of an inverted cone with a generally central opening or orifice 11 at the top of the cone. The slope of the cone may vary from application to application, however, it should be high enough to allow gas bubbles to migrate upwardly and to the middle of opening 11 without coalescing, while not so steep that it occupies vertical space unnecessarily.

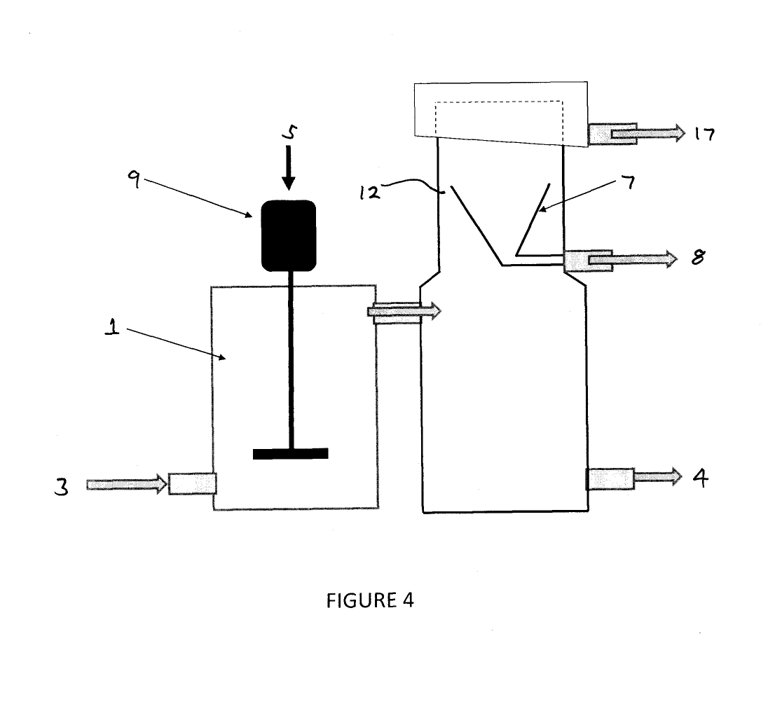

FIG. 4 shows an alternate embodiment of flow restrictor 7. Here, the flow restrictor is a cone forming an annulus 12 between the upper end of the cone and the interior diameter of second vessel portion 2, with the annulus being generally centrally positioned within the vessel. That is, a flow restrictor in the form of a cone having a diameter smaller than the diameter of second vessel portion 2 creates an annulus between the outer edge of the cone and the inner surface of the vessel through which bubbles are allowed to flow upwardly at an increased velocity. Entrained slurry within the bubbles and particles that are dislodged and dropped back from the froth (i.e. froth underflow) are collected within the cone and withdrawn through a conduit connected to the bottom of the cone and eventually directed through particle drop back output 8.

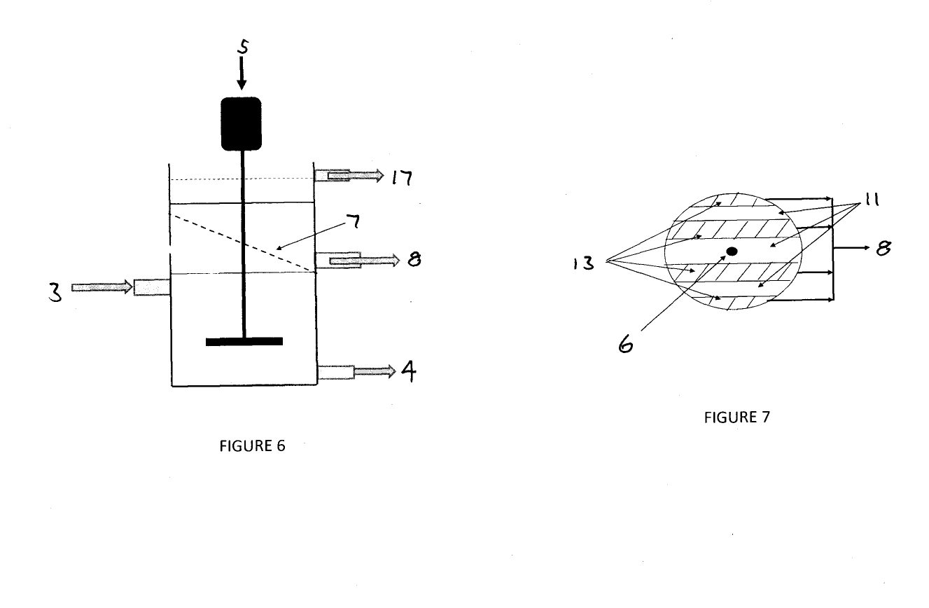

FIGS. 6 and 7 demonstrate a third embodiment of flow restrictor 7. Here the flow restrictor is comprised of a set of generally parallel, upwardly oriented, troughs 13. The troughs are spaced apart creating openings 11 through which bubbles are allowed to flow upwardly, once again at an increased velocity. Any entrained slurry or drop back particles in the froth recovery unit fall back and are collected within the individual troughs and directed to particle drop back output 8. This particular configuration of the flow restrictors is more conducive to being used in column and contact flotation cells than in mechanical flotation cells.

Although different configurations of flow restrictors or throttling plates (including those described herein) can be used in conjunction with the present invention, in each instance their function is the same, in that the flow restrictors throttle the upward flow of bubbles and slurry and permit the bubbles to enter a chamber or area within a vessel from which particle drop back is recovered. Particles that are dropped out of the froth, and slurry that is carried upwardly with the bubbles are recovered, collected and discharged through a separate particle drop back output and do not find their way into the tailings output. Accordingly, regardless of the positioning and nature of the flow restrictor, particle drop back output 8 will be positioned and associated with the flow restrictor in a manner to direct drop back particles and slurry to a separate designated discharge stream. The flow restrictor thus assists in preventing particles that drop out of the froth from falling back into the slurry as the upward velocity of the gas bubbles helps to restrict drop back particles from falling downwardly through the opening in the flow restrictor. The separate froth underflow stream may then be directed to a specific treatment process or, alternatively, recycled back to the feed slurry input line to allow it to once again be subjected to froth flotation in order to recover the hydrophobic particles.

Although the froth drop back phenomena has been known for quite some time, prior methods have not been derived or applied to separately capture froth drop back particles in a commercial flotation vessel or flotation cell. In one aspect the present invention thus allows for the drop back particles to be separately collected and diverted (and perhaps re-ground) to the head of the circuit to increase efficiencies.

The invention further permits the application of a higher power density to the mechanical agitation stage by physically separating mechanical agitation from bubble-slurry disengagement and froth recovery. In so doing a higher power density can be applied than in the case of typical mechanically agitated flotation cells, hence the volume required for particle collection can be lower. Attempting to increase the power utilized by existing mechanical cells to rates approaching that as permitted by the present invention tends to have the negative consequence of causing turbulence which disrupts the process of bubble disengagement and froth recovery (both of which occur in the upper half of the flotation vessel in standard mechanically agitated flotation machines). Accordingly, the employment of the mechanically agitated and pressurized particle collection unit of the present invention permits the use of smaller flotation cells which can have a noted advantage in terms of capital costs.

It has also been discovered that utilization of a pressurized particle collection unit has the tendency to reduce particle drop back. As mentioned above, to achieve sufficient residence time, current flotation machines tend to be large in size with significant surface areas. As a result, their froth depth tends to be relatively shallow. With a large surface area The vessel walls provide little bubble support. That, combined with a shallow froth depth, tends to result in high particle drop back. When a pressurized particle collection unit is used there is presented an ability to utilize a considerably smaller bubble disengagement unit with a considerably smaller surface area. The smaller bubble disengagement unit allows for the formation of a deeper layer of froth which, together with the wall support provided by the smaller vessel, has been found to allow the bubbles to better support one another with less bubble popping. The net result is that with fewer bubbles in the froth popping before they are withdrawn in the froth discharge, less particle drop back occurs. This can be particularly advantageous in the last cells of a rougher or scavenger flotation circuit where the froths are generally sparse and the least stable. In smaller roughing and scavenging flotation circuits where vessel diameters are generally small, there may be cases where the flow restrictor is not required. Accordingly, in one aspect the invention concerns the use of a pressurized particle collection unit and a bubble disengagement unit that does not include a flow restrictor.

In addition, through separating the particle collection stage from the bubble disengagement stage, generally much less air or gas is required for particle collection. It has been found that in some instances as much as a 70% reduction in the amount of required gas is achievable. The use of lower amounts of air can provide a significant improvement over conventional mechanically agitated flotation cells as less water tends to report to the froth and therefore less undesirable minerals get carried with the water. Further, using less air results in a reduction in the amount of energy required to generate the air via a compressor or blower, and can often result in the ability to draw mixing power with less tank baffling and fewer wear opponents.

The advantages of the invention are even more pronounced where froth wash water is used in applications such as final cleaning. In applications where wash water is utilized, the froth drop back tends to increase considerably and hence the ability to capture particles that drop out of the froth is even more significant.

A further advantage of the present invention is that the surface area of the froth recovery unit is independent of the surface area of the bubble disengagement unit. The separation of the froth recovery unit from the bubble disengagement unit by means of the flow restrictor allows a bubble disengagement unit to be designed with a surface area optimized for bubble disengagement while permitting a design that optimizes the surface area of the froth recovery unit for froth removal. In many instances the optimized surface area for the two flotation stages will not be the same, with the optimized surface area for the froth recovery unit usually being proportional to the flow rate of solids mass to be removed.

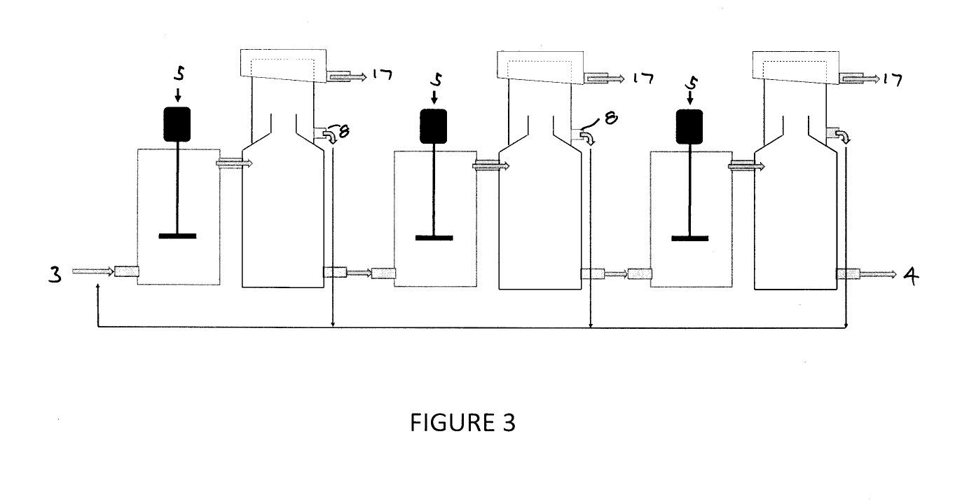

As mentioned previously, it is expected that typically a number of flotation cells constructed in accordance with the present invention will be connected together in series to form a flotation circuit. One example of such a flotation circuit is shown in FIG. 3, which contains 3 separate flotation cells. Here, the particle drop back output stream is directed back to the first stage of the flotation circuit so that the material that is collected at the drop back output can be re-processed. The discharge stream from the particle drop back output can also be re-ground prior to being directed back to the head of the flotation circuit.

A variety of alterations can be made to the mechanical structure of the invention while remaining within its broad scope. For example, while in the attached drawings the feed slurry input is shown to be approximately perpendicular to the vessel wall, the feed can also be introduced tangentially or multiple input ports could be present. The agitator can also take a variety of different forms. It is expected that in most instances one of any wide variety of commercially available or custom built impellers (driven by a motor 9) will be used, depending upon the particular application at hand and considering criteria such as gas holdup in the particle collection unit, the abrasiveness of the slurry, particle size, impeller efficiency, how and where gas is introduced, impeller wear characteristics, and efficiency at drawing power.

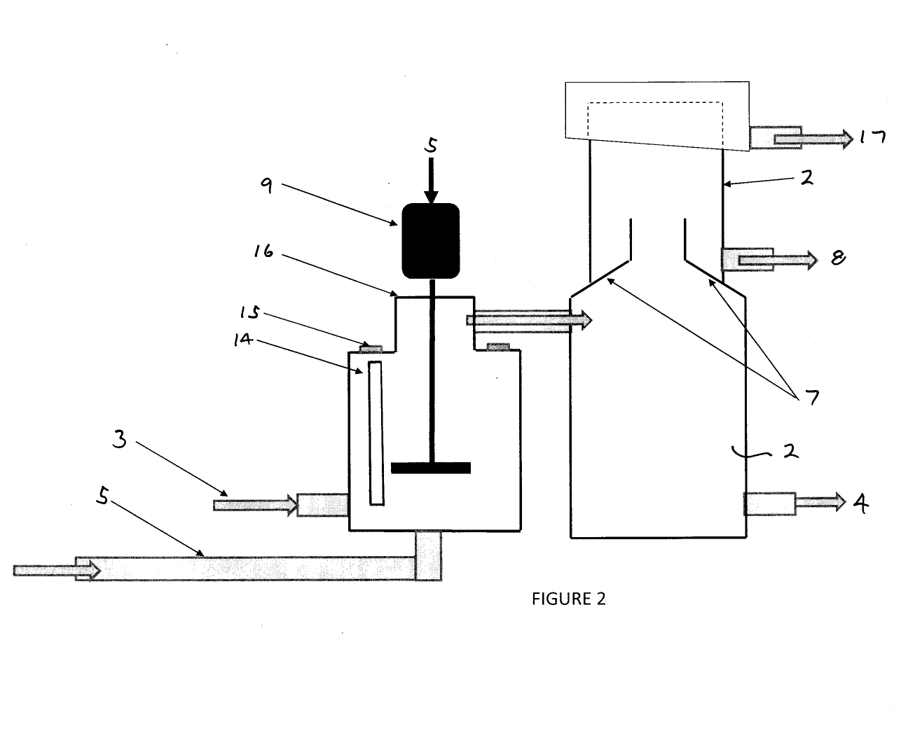

Typically the particle collection will contain a number of baffles 14 (in FIG. 2) to help break the vortex created by the agitator, to allow for higher power draw in the tank and to permit higher bubble/particle collision probability.

In lieu of baffling, a stator approach can be used in conjunction with the impeller in order to create the power draw, gas holdup and slurry suspension required. A stator is simply a series of closely spaced vertical baffles (for example 18 to 24) that are positioned about the agitator's impeller. This has been the standard approach used for decades in conventional mechanically agitated. Accordingly, the current invention provides the flexibility of using a limited number of baffles or utilizing a more conventional stator approach. As shown in FIG. 2, the particle collection unit may have incorporated into it a series of hatches or access ports 15 permitting the withdrawal of the baffles for inspection or replacement without the need for opening the top of the vessel and removing the agitator.

With reference to FIGS. 1 and 2, there are also depicted two embodiments for the particle collection unit. In FIG. 1, the particle collection unit is in the form of a standard pressure tank or vessel with the agitator typically being received through its upper surface. In the case of the embodiment shown in FIG. 2, the particle collection unit has a separate small cylindrical portion 16 situated on the top of the unit through which the agitator enters. Either version of the particle collection unit can be utilized, however, the raised cylinder 16 allows for a uniform exit of the slurry from the particle collection unit so that mixing patterns are minimally affected.

In the embodiment of the invention shown in FIGS. 1 through 4, the froth recovery unit is attached to (sits on top of) the bubble disengagement unit. However, the froth recovery unit can also be separated from the bubble disengagement unit and hydraulically connected by a pipe or conduit. Several froth recovery units and bubble disengagement units can also be combined into one larger vessel as a further option.

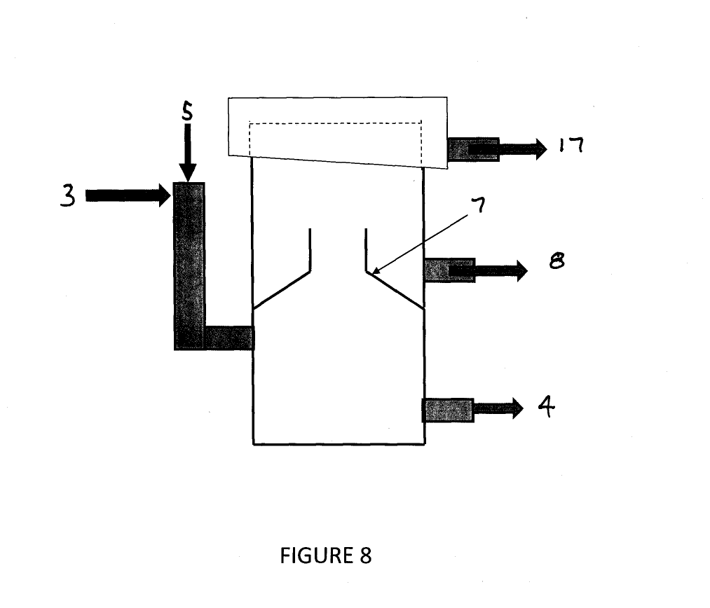

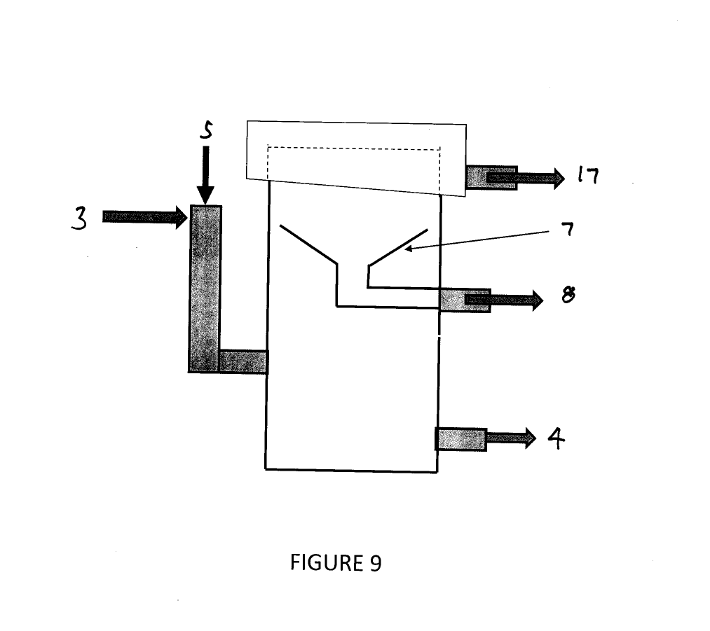

Additional embodiments are shown in FIGS. 5 through 9. In these figures, the flow restrictor or throttling plates that create the interface between the bubble disengagement unit and a froth recovery unit (and that allow for the creation of a froth underflow stream of concentrated froth drop back particles) are shown as used in a mechanical flotation machine (FIG. 5) and a contact cell (FIGS. 8 and 9). In each instance, the flotation cell will typically be comprised of a single flotation vessel and not the dual vessel configuration shown in FIG. 1. In the case of the mechanical flotation machine of FIG. 5, there is no separate particle collection unit since the lower portion of the vessel serves as both the particle collection unit and the bubble disengagement unit. The upper portion of the vessel serves as the froth recovery unit and is separated from the lower by flow restrictor 7. In general, such a structure will normally be less efficient than having a separate particle collection unit, however, it can still represent a significant improvement over mechanically agitated flotation cells that are currently in use. Where a separate particle collection unit is not utilized, the feed slurry input is preferably just below the flow restrictor and the tailings output is positioned at or toward the bottom of the cell.

The application of the invention to contact cells, as shown in FIGS. 8 and 9, is generally similar to that of the case where the invention is applied to a mechanical flotation machine, with the exception that no agitator is typically employed in a contact cell.

With a complete understanding of the invention, one of ordinary skill in the art will appreciate that the employment of the described and inventive apparatus and methodology presents the ability to produce a separate output stream comprised of a concentration of particles that have dropped out of the froth. These particles are largely hydrophobic particles that have already been collected by gas bubbles, but that have been rejected in or at the froth phase. In prior art flotation units froth drop back particles would have a higher probability of being lost through the tailings discharge and would have to be recovered again in a subsequent collection stage. The present invention reduces the occurrence of froth drop back particles in the tailing stream of the flotation cell, thereby enhancing the overall efficiency and recovery of the cell. Further, it will also be appreciated that separating the particle collection unit from the bubble disengagement unit, regardless of whether a flow restrictor is utilized, presents the ability to create much higher bubble shear and to optimize retention time for particle collection, adding to the efficiency of the overall operation. A further embodiment of the invention thus comprises the use of at least two flotation vessel portions with the first vessel portion (the vessel into which slurry and gas are delivered) comprising the particle collection unit (as an agitated pressurized vessel or tank) with the process of bubble disengagement and froth recovery taking place in one or more additional vessels.

It is to be understood that what has been described are the preferred embodiments of the invention and that it may be possible to make variations to these embodiments while staying within the broad scope of the invention. Some of these variations have been discussed while others will be readily apparent to those skilled in the art.

1. A flotation cell comprising:
a first vessel portion, said first vessel portion having a feed slurry input, an agitator and a gas input located in or operatively connected thereto, said first vessel portion comprising a mechanically agitated pressure vessel and acting as a particle collection unit; and
a second vessel portion having a tailings output and a froth discharge operatively connected thereto, said second vessel portion hydraulically connected to said first vessel portion and receiving agitated slurry and gas from said first vessel portion, said second vessel portion acting as a bubble disengagement unit.

2. The flotation cell as claimed in claim 1, wherein said second vessel portion includes a flow restrictor and a particle drop back output, said flow restrictor positioned vertically higher in said second vessel portion than the point of entry of said agitated slurry and gas, said flow restrictor limiting the drop back of floated particles into the slurry and directing drop back particles to said particle drop back output.

3. A method of froth flotation comprising:
delivering a slurry containing hydrophobic particles to a first vessel portion of a flotation cell, the first vessel portion comprising a pressure vessel;
injecting gas into the slurry either prior to or after the slurry enters the flotation vessel;
mechanically agitating the slurry to cause the adherence of gas bubbles to the hydrophobic particles, said first vessel portion acting as a particle collection unit; and
transporting the agitated slurry and gas into a second vessel portion to permit bubble disengagement from the slurry and particle separation in a vessel distinct from the particle collection unit.

4. The method as claimed in claim 3 further including collecting drop back particles that become disengaged from gas bubbles within the froth of the second vessel portion and directing the particles to a particle drop back output to limit the mixing of the drop back particles with the slurry and to limit the diversion of drop back particles to tailings.

5. The method as claimed in claim 4, wherein said step of limiting the mixing of the drop back particles with the slurry comprises utilizing a flow restrictor in the second vessel portion, the flow restrictor positioned vertically higher in the second vessel portion than the point of entry of the slurry and gas.

6. A flotation cell for froth flotation, the flotation cell comprising:
one or more flotation vessels;
a feed slurry input;
a tailings output;
a froth output;
a gas input;
a flow restrictor positioned in one of said one or more flotation vessels; and a particle drop back output associated with said flow restrictor,
wherein said flotation cell undergoing froth flotation said flow restrictor limiting the drop back of floated particles into the slurry and directing drop back particles to said particle drop back output.

7. The flotation cell as claimed in claim 6 wherein said flow restrictor is an inverted cone with a generally central opening, a cone forming an annulus between its outer surface and the inner surface of the flotation vessel within which it is situated, or is a series of generally upwardly facing troughs.

8. The flotation cell as claimed in claim 6, wherein said flow restrictor restricts upward flow within the vessel that it is situated, said flow restrictor positioned vertically higher in the vessel than said feed slurry input.

9. The flotation cell as claimed in claim 6, wherein the first and second flotation vessels that comprise first and second vessel portions, said first vessel portion including an agitator and comprising a mechanically agitated pressure vessel.

10. The flotation cell as claimed in claim 9, wherein said feed slurry input and said gas input are located in or operatively connected to said first vessel portion; said flow restrictor, said tailings output, said froth output and said particle drop back output located in or operatively connected to said second vessel portion; said first and said second vessel portions hydraulically connected by a transfer conduit; said flow restrictor positioned vertically higher in said second vessel portion than said transfer conduit.

11. The flotation cell as claimed in claim 10 wherein said flow restrictor is an inverted cone with a generally centrally located opening, a cone having a generally central annulus, or a series of generally upwardly facing troughs.

12. The flotation cell claimed in claim 10 including a third vessel portion, said first vessel portion comprising a particle collection unit, said second vessel portion comprising a bubble disengagement unit, said third vessel portion comprising a froth recovery unit, said flow restrictor positioned between said second and third vessel portions.

13. A method of froth flotation, the method comprising:
directing a feed slurry to a flotation vessel;
injecting gas into the feed slurry either prior to or after the slurry enters the flotation vessel;
agitating the slurry to cause gas bubbles to attach to hydrophobic particles in the slurry such that the bubbles and the attached hydrophobic particles rise within the vessel and form a froth;
with a flow restrictor, positioned higher in the vessel than the point of entry of the feed slurry, diverting drop back particles from the froth to a particle drop back output, thereby limiting the intermixing of the drop back particles with the slurry and limiting the diversion of the drop back particles to tailings.

14. The method as claimed in claim 13, wherein the feed slurry is transported to a first vessel portion, said first vessel portion acting as a mechanically agitated pressure vessel, said gas injected into said slurry in said first vessel portion, said method further including agitating the slurry and said injected gas in the first vessel portion.

15. The method as claimed in claim 14 further including transporting the agitated slurry and gas into a second vessel portion, the second vessel portion containing the flow restrictor and acting as a bubble disengagement unit.
